(19) United States
(12) Patent Application Publication
(10) Pub. No.: US 2007/0151958 A1
(43) Pub. Date: Jul. 5, 2007

(54) Laser cutting apparatus

(76) Inventor: Christopher Max Modra, Springwood (AU)

Correspondence Address: YOUNG & THOMPSON, 745 SOUTH 23RD STREET, 2ND FLOOR, ARLINGTON, VA, 22202, US

(21) Appl. No.: 10/540,221

(22) PCT Filed: Dec. 19, 2003
(86) PCT No.: PCT/AU03/01703

§ 371 Date: Mar. 9, 2006

(30) Foreign Application Priority Data
Dec. 19, 2002 (AU) 2002593443

(51) Int. Cl. B23K 26/14; B23K 26/16

(52) U.S. Cl. 219/121.67

(57) ABSTRACT

A laser cutting apparatus includes a table bed having a perforated top surface for positioning a sheet material thereon, a gantry extending across the bed and arranged to travel along the bed, and a carriage arranged to travel along the gantry. The bed has a holding arrangement for holding the sheet material in position on the bed. The carriage has a laser head with a nozzle and is arranged to receive a laser source and direct a laser beam through the nozzle and towards the bed for cutting the sheet material. An enclosure member having a first low pressure chamber therein is arranged about the laser nozzle. The first chamber has a suction opening for entraining substantial by-products produced during cutting of the sheet material into the first chamber and for causing a part of the sheet material under the suction opening to be lifted off the top surface.

### TECHNICAL FIELD OF THE INVENTION

This invention relates to a laser cutting apparatus for cutting sheet materials, and in particular but not limited thereto, the laser cutting apparatus is configured to cut patterned fabrics for blinds.

### BACKGROUND OF THE INVENTION

Laser generating devices have been used in many cutting applications. In general, in these devices there is a focussed laser beam directed onto a sheet material to be cut and the beam is controlled to travel in a path over the material. The path describes a trajectory which corresponds to the desired cutting profile. For a blind or any other shaped product, the cutting profile may include a desired pattern. Thereby, the material is cut into a patterned profile that is determined by the travel path of the beam. As the laser beam generates a substantially high heat in cutting, smoke and fumes are inevitably produced during the cutting operation. The cut material can be stained by the smoke and fumes. As the stained materials cannot be used in a good quality product they are generally discarded as wastes. Therefore, there is a considerable amount of wastes in the production of laser cut sheet materials. The applicant has estimated that in the production of laser cut fabrics for blinds only about 75 percent of the cut fabrics are useable as the remainders are damaged by smoke stain and fumes.

A sheet material to be cut must be held down on a bed during the cutting operation. Clamps or relatively heavy plastic films have been employed for this purpose. Both the clamps and the plastic films are manually applied to the sheet material. Accordingly, the use of these articles for holding a sheet material does not allow for a fully automated cutting process of sheet materials.

The cut sheet material has a trim around the desired cut panel. The trim and the cut panel must be removed from the cutting station by separate actions. While any of them remains in the cutting station, a new sheet material can not be positioned in the cutting station for a cutting operation. Accordingly, the separate actions needed to remove the trim from the panel of a cut sheet material present a delay in recommencing of repeated cutting operations.

The trim and the cut panel are usually picked up by a clamping device. As the trim and the cut panel lie flat on the bed, a part of the clamping device must be positioned under them before a clamping action can be effected. The applicant has observed that when positioning the part of the clamping device under the trim or cut panel, the material may not be completely flat when it is being clamped. As such, the material may be unnecessarily folded with permanent fold lines and would have to be discarded.

Some cut panels require creases to be formed thereon so as to allow folding about the crease lines to form a desired pattern. In the prior art, the action to impart creases is done as a separate operation at a location outside the cutting zone. Again, for this reason a fully automated process is hindered.

### OBJECT OF THE INVENTION

An object of the invention is to substantial alleviate or to reduce to a certain level one or more of the prior art disadvantages.

### SUMMARY OF THE INVENTION

In one aspect the present invention resides in a laser cutting apparatus for cutting sheet materials. The apparatus includes a bed having a top surface for a sheet material to be positioned thereon, a gantry arranged to controllably travel in a first direction along the bed and configured to extend over the bed in a second direction that is substantially transverse to the first direction, and a carriage being arranged to controllably travel along the gantry. The bed has a holding arrangement for holding the sheet material in position on said top surface. A laser head is located on the carriage. The laser head has a laser nozzle and is arranged to receive a laser beam from a laser source and to direct the laser beam through the laser nozzle and towards the bed for cutting the sheet material. An enclosure member having a first low pressure chamber therein is arranged about the laser nozzle. The first chamber is arranged so that the pressure therein is lower than atmospheric pressure and has at least one suction opening positionable beneath the laser nozzle for entraining a substantial amount of by-products produced during cutting of the sheet material into the first chamber and for causing a part of the sheet material under the suction opening to be lifted off the top surface.

In another aspect the present invention provides a laser cutting apparatus comprising:
1) one or a series of rollers on which one or more rolls of a sheet material are placed;
2) a flat bed table on which the sheet material is laid out and the bed table is arranged to hold the sheet material in place by suction;
3) a gantry is arranged to move in a first direction along the table;
4) a gripping device and a controllably movable carriage mounted on the gantry, the gripping device being arranged to controllably clamp the sheet material and to pull the sheet material across the table, and the carriage being arranged to move along the gantry in a second direction which is substantially transverse to said first direction; and
5) the carriage having mounted thereon at least one controllable crease wheels forforming crease lines into the sheet material, and a controllable laser head for cuffing the sheet material.

In a further aspect the present invention resides in a laser head for a sheet material cutting apparatus. The laser head comprises a laser nozzle arranged for to receive a laser beam from a laser source and to direct the laser beam therethrough and towards the sheet material, and an enclosure member being arranged about the laser nozzle and having a first low pressure chamber therein. The first chamber is arranged so that the pressure therein is lower than atmospheric pressure and has at least one suction opening positionable beneath the laser nozzle for entraining a substantial amount of by-products produced during cutting of the sheet material into the first chamber. A cover having a series of apertures is arranged to be selectively movable to a position(s) in alignment with the or each of said at least one suction opening and while being moved the by-products caught in the apertures are removed by interaction with the enclosure member.

The cover may be arranged to be movably mounted on the enclosure member. A retention arrangement may be provided for retaining said cover at the position(s) of alignment. Typically, the retention arrangement has spaced retention holes in said cover and the retention holes are configured to receive retention elements on said enclosure member. In one form the retention elements are bearings biassed to be receptive in said retention holes when an aperture(s) in said cover is in the alignment position(s), and upon applying a force to move said cover the bias on the retention bearings is overcome and the bearings thereby retreating from the retention holes to allow movement of the cover relative to the enclosure member towards a subsequent alignment position(s).

In yet another further aspect the present invention resides in a gripping device for a cutting apparatus having a flat bed table on which a sheet material to be cut is laid out. The gripping device comprises an upper plate member and a lower plate member arranged to move in a first direction along the table and to controllably clamp a leading edge of the sheet material. The lower plate member is arranged to be movable relative to said upper plate member between a clamping position for clamping the sheet material therebetween and a pickup position for picking up the leading edge. The lower plate is configured with a front edge opposite to said leading edge and is arranged so that at said pickup position movement thereof to contact the sheet material causes a relatively small part or parts along the leading edge come into an initial contact with the front edge and further movement thereof causes other parts along the leading edge to progressively come into contact with the front edge and to lie over the front edge for clamping between the upper and lower plate members.

It is preferred that the front edge is knife edge shaped. It is also preferred that the front edge is wavy shaped with one or more crests.

The lower plate may have a substantially straight front edge and is pivotally mounted at one end thereof. The lower plate is controlled so that at said initial contact the front edge is at an angle to said leading edge and thereafter the lower plate is pivotally move in a plane parallel to the flat bed of said table so that the front edge is substantially parallel to said leading edge.

In preference, the holding arrangement includes a second low pressure chamber arranged below the bed and a plurality of through holes extending through the top surface and in fluid communication with the second chamber. The second chamber is arranged so that the pressure therein is lower than atmospheric pressure. Thus, any by-products below the sheet material is sucked into the second chamber. It is also preferred that a relatively high volume but low pressure air is arranged to flow through the holes into the second chamber.

It is preferred that the first chamber and the second chamber are substantially in a vacuum.

Air flows through the first and second chambers may be controlled so that there is an air gap between the suction opening and the lifted part of the sheet material. Air is then caused to flow through the air gap into the first chamber. This assists in the entrainment of the by-products above the sheet material to flow into the first chamber.

Controllable crease wheels may be arranged on the carriage for forming creases in the sheet material. The wheels may have a relatively large diameter in comparison to said through holes. The wheels may be configured with a profile to limit depth of creases in the sheet material. The wheels may be in the form of a single or dual edge profile. Each of the wheels with a single edge profile may have a main wheel body and an edge portion extending around and protruding from the main body. Each of the wheels with a dual edge profile may have a main wheel body and spaced edge portions extending around and protruding from the main body.

The carriage may also have a controllable gripping device for gripping a leading edge of the sheet material for positioning same on the bed. The gripping device may have a plate which is movable and is arranged to move upwardly to clamp the leading edge thereon when positioning the sheet material. The plate may have a front edge with one or more pointed or curved sections forward of remaining sections of the front edge, and the one or more pointed or curved sections are arranged to make initial contact with portions of the leading edge of the sheet material before the remaining sections come into contact with the leading edge. The one or more pointed or curved sections, on contact with the portions of the leading edge, cause the contacted portions to initially bend and then relax to lie flat on said one or more pointed or curved sections. This arrangement prevents folding of the sheet material when clamped by the gripping device. In a gripping process, the gripping device is preferably controlled to lower its plate on the bed and move to slide under the leading edge of the sheet material and then to retreat a short distance before returning to clamp the sheet material.

The sheet material may be arranged in a roll form supported on rollers adjacent to the bed. The sheet material can be a fabric or cloth.

The sheet material may include all kinds of synthetic and natural cloth as used for blinds, awnings, curtains, outdoor ‘sails’, shadecloth, or ‘screen’ cloth.

### BRIEF DESCRIPTION OF THE DRAWINGS

In order that the system of the present invention can be readily understood and put in practically effect the description will now refer to the accompanying drawings which illustrate non-limiting embodiments of the present invention and wherein:

FIGS. 1 and 2 are respective schematic side and plan views of a frame of a laser cutting apparatus according to an embodiment of the process according to the present invention;

FIG. 3 is a schematic end view of the frame shown in FIG. 1;

FIG. 4 is an enlarged view of the laser head shown in FIG. 3;

FIG. 5 is a detailed cross-section view of the laser head and the bed of the embodiment of the apparatus shown in FIG. 4;

FIG. 6 is a schematic cross-section view of another embodiment of the laser head;

FIG. 7 is a perspective view of a housing member for the laser head shown in FIG. 6;

FIG. 8 is an elevation of the laser head shown in FIG. 6;

FIG. 9 shows an embodiment of the crease wheels for the apparatus according to the present invention;

FIGS. 10 and 11 respectively show a side view and a plan view of a further embodiment of the apparatus according to the present invention;

FIG. 12 shows an embodiment of the gripping device for the present invention;

FIGS. 13 and 14 show the steps in clamping the fabric;

FIG. 15 shows an application of an embodiment of the apparatus of the present invention for cutting a fabric cut into a pattern for a blind; and

FIG. 16 shows another embodiment of the gripping device for the present invention.

### DETAILED DESCRIPTION OF THE DRAWINGS

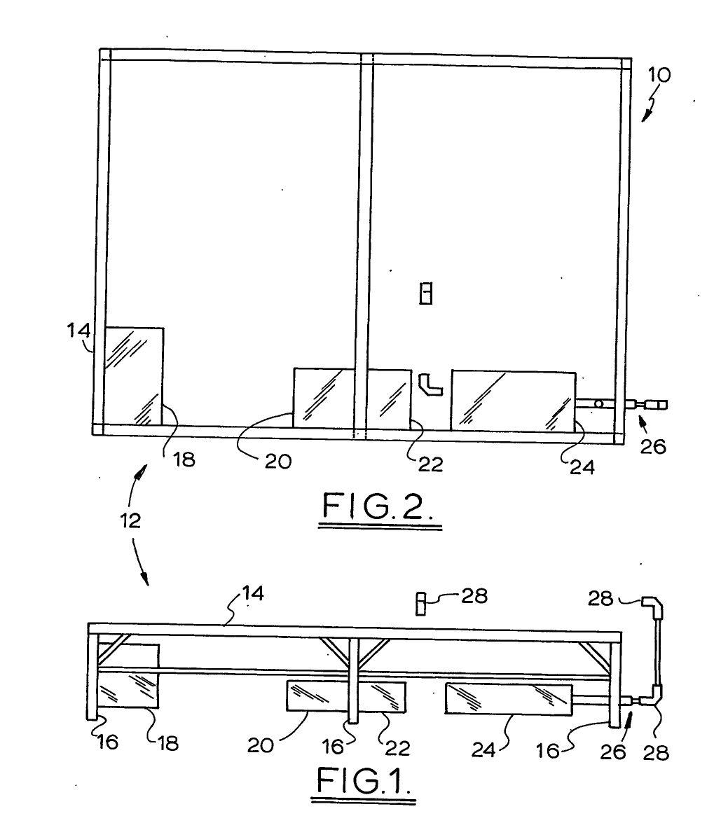

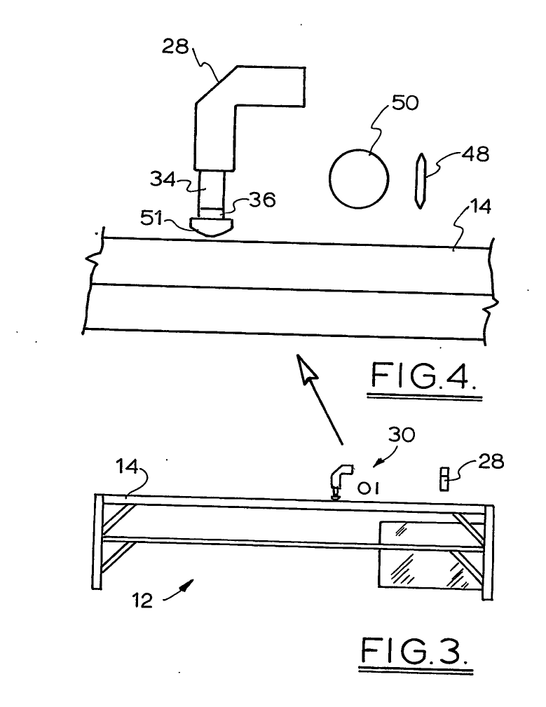

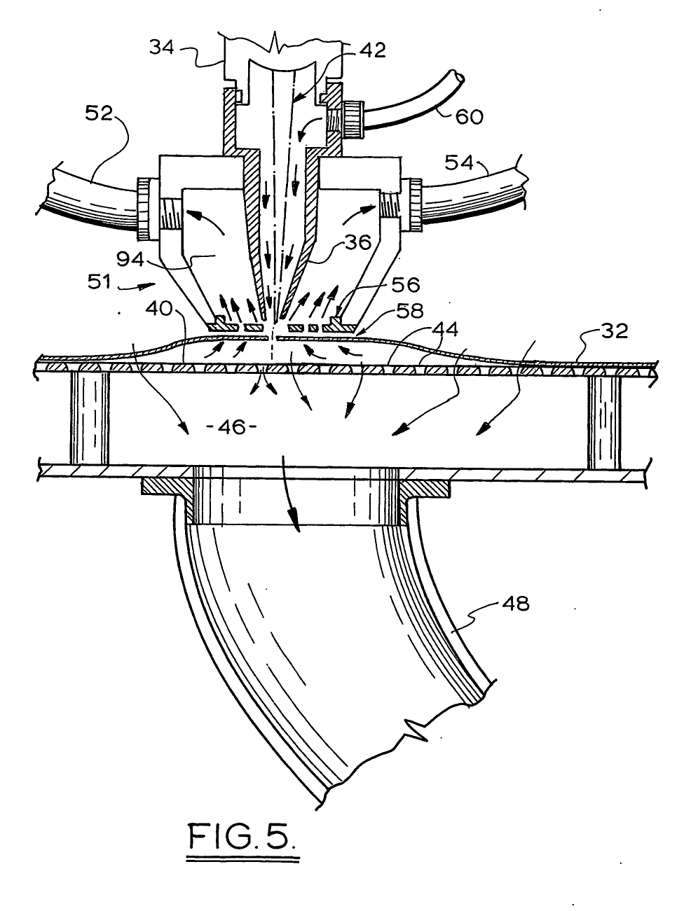

Referring to the drawings and initially to FIGS. 1 and 2, there is shown an embodiment of a frame 12 for a bed of a laser cutting apparatus 10 according to the present invention. The bed frame 12 has a rectangular top frame portion 14 supported by spaced legs 16. Supported on the frame 12 are a main control box 18 for a computer based control equipment, a laser coolant system 20, a power supply 22, a laser generator 24, a collimator arrangement 26 for collimating the laser energy from the laser generator 24, and a series of mirror assemblies 28 for directing the laser energy to a laser head 30 (see FIGS. 3 and 4). As shown in FIG. 4, the laser head 30 has a mirror arrangement 28 for directing the laser energy downwardly, and a lens assembly (not shown) for focussing the energy as a laser beam onto a sheet material 32 (see FIG. 5) to be cut. For adjusting the laser focus, a vernier type adjuster 34 is provided to adjust the relative distance between the lens assembly and a laser nozzle 36. Typically, the laser beam 42 is focussed to impart maximum energy onto a top surface 40 of the the bed frame 12. The top surface 40 supports the sheet material 32 for cutting. In this case the sheet material is a fabric for making a blind.

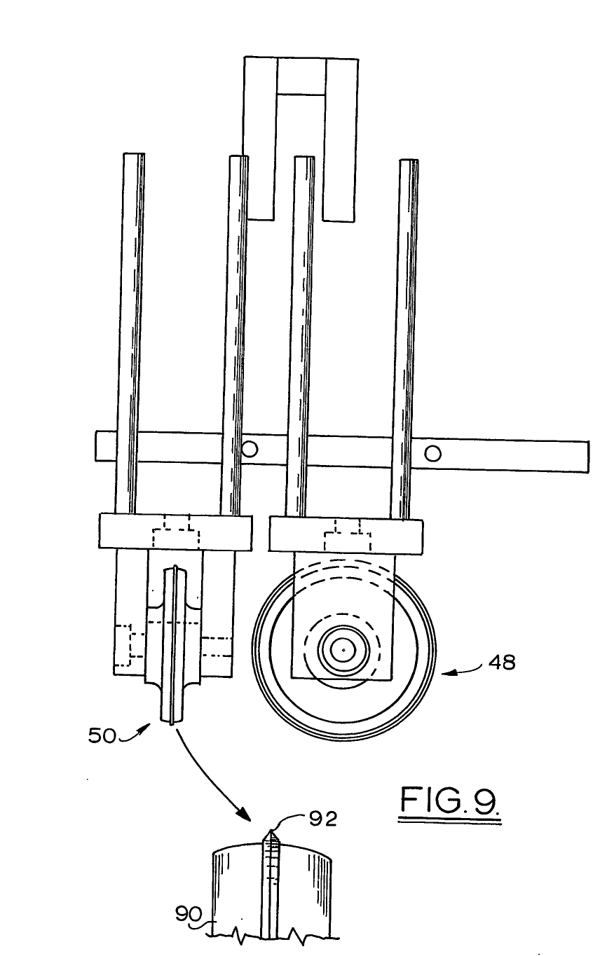

To hold the fabric 32 to the bed surface 40, the apparatus uses the principle of high air flow through the fabric and therefore applies a downward force on the fabric 32. For this purpose, the support surface 40 is a plate with a pattern of small holes 44 in it. The holes 44 form inlet ports of a vacuum chamber 46 and are such as to allow an appropriate volume of air to flow through the plate 40. A hose 48 is connected to the chamber 46 and a suction machine (not shown) draws air through the holes 44 into the chamber 46 and the air is guided by the hose 48 to flow into the atmosphere. The holes 44 are sized so as to allow creasing wheels 48 and 50 (see FIGS. 4 and 9) to travel over any one of them without damaging the fabric 32. Otherwise, as a wheel rolls into a hole 44 and out again (ie the pinch point effect), damage to the fabric 32 is possible. The creasing wheel profile is designed such as to minimise the pinch point effect by using either a shallow angle relative to the surface of approximately 20 degrees or a single or dual edge profile which prevents the wheels from ever fully entering the hole 44. In one form the wheels 48 and 50 have a single edge profile and as shown more clearly in the enlarged partial view they have a cylindrical main body 90 and an annular crease edge 92 around the circumference of the main body 90. In this embodiment, the crease edge 92 is configured with a depth extending from the outer periphery of the main body 90 and the depth is less than the thickness of the fabric 32. In another arrangement, the laser head 30 is control led to heat the fabric 32 just ahead of the wheels 48 and 50 so that the deformation for the crease or scoring effect is more permanent and easier to form.

The apparatus 10 has another vacuum chamber 94 within a housing member 51 around the laser nozzle 36. The vacuum chamber 94 is connected to a vacuum pump (not shown) by means of tubes 52 and 54. The lower end of the vacuum chamber 94 in this embodiment has an opening and a vacuum nozzle plate 56 with apertures is supported in the opening. The vacuum chambers 46 and 94 are arranged so that the fabric 32 is held in the position as shown except for a portion under the vacuum nozzle plate 56. That portion as shown, is lifted off the surface 40 by an air stream that is flowing into the vacuum chamber 94. The differential between the air pressures in the two chambers is such that a small air gap 58 forms between the nozzle plate 56 and the fabric 32. The laser nozzle 36 also has a tube 60 connected to allow compressed air to flow into the interior of the nozzle 36 and then out therefrom. The arrangement of the two vacuum chambers eliminates smoke and heat damage to the fabric 32 by two processes. Firstly, a stream of air jet blasts the vaporised and burnt materials away from the underside of the fabric 32. Secondly, the vacuum in the chamber 94 and around the nozzle 36 assists in drawing away smoke from the upper side of the fabric and around the cut region. The lifting of the fabric 32 from the surface 40 provides a clearance underneath the fabric 32 to allow smoke and debris to disperse downwards and not bounce back up onto the fabric 32. It also draws the fabric 32 close to the vacuum chamber 94 so smoke and debris are drawn away rapidly from above by the air flow caused by the vacuum in the chamber 94. The end nozzle plate 56 allows the laser head 30 to slide with ease over the fabric 32, in part due to a cushioning effect generated by the air flow that is created by the vacuum in the vacuum chamber 94

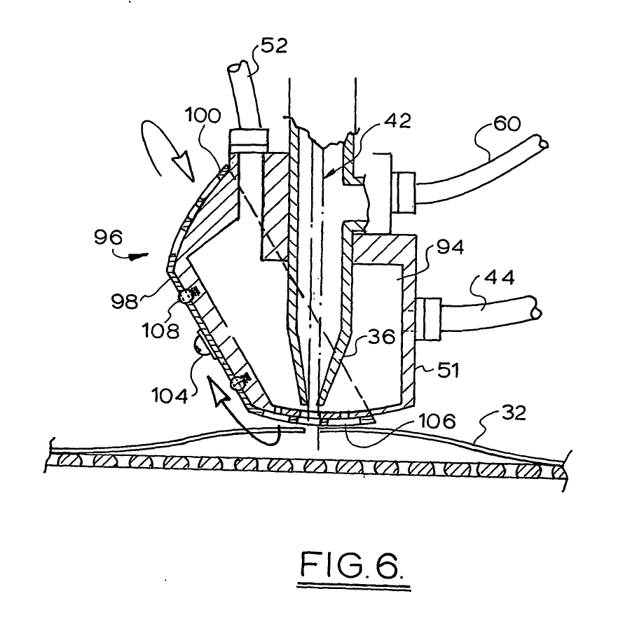

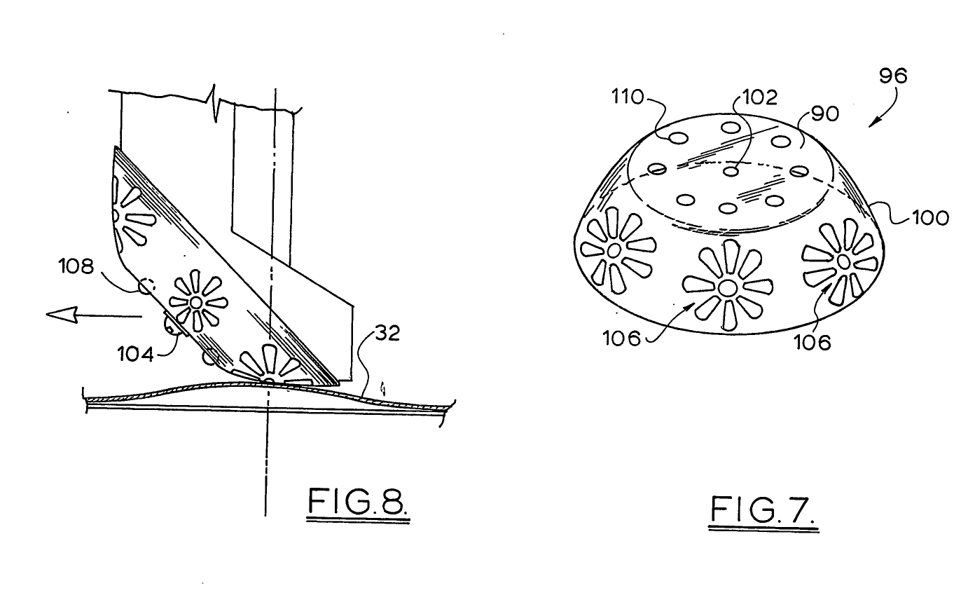

Turning to FIGS. 6 to 8, there is shown another embodiment of the laser head. In this embodiment, the housing member 51 of the laser head 30 has a section which is shaped for a bowl shaped element 96 to be secured thereto. This section has an opening in alignment with said laser nozzle 36 so that the laser beam 42 can be directed through the opening onto the fabric 32. The bowl shaped element 96 has a base 98 and a side wall 100 extending from the base 98. The side wall 100 has a number of sets of aperture 106 and the base 98 has a mounting hole 102 for a screw 104 to enter therein for securing the element 96 to the hosing member 51. The bowl shaped element 96 can be rotated about the screw 104 so that a set of the apertures 106 can be selected positioned under the opening in the housing member 51. The rotating action moves the set of apertures 106 currently under the opening onto a surface of said housing member 51 and the interaction therebetween helps to clean any by-products gathered in and around that set of apertures 106. To retain the bowl shaped element 96 in position, the housing member 51 has spaced ball bearings 108 spring biassed to extend into bearing apertures 110. The bias on the ball bearings 108 is overcome by applying a rotating force to the bowl shaped element 96. Accordingly, to select another set of apertures 106, one simply needs to apply a force of sufficient magnitude to turn the element 96 until the ball bearings 108 reenter the apertures 110.

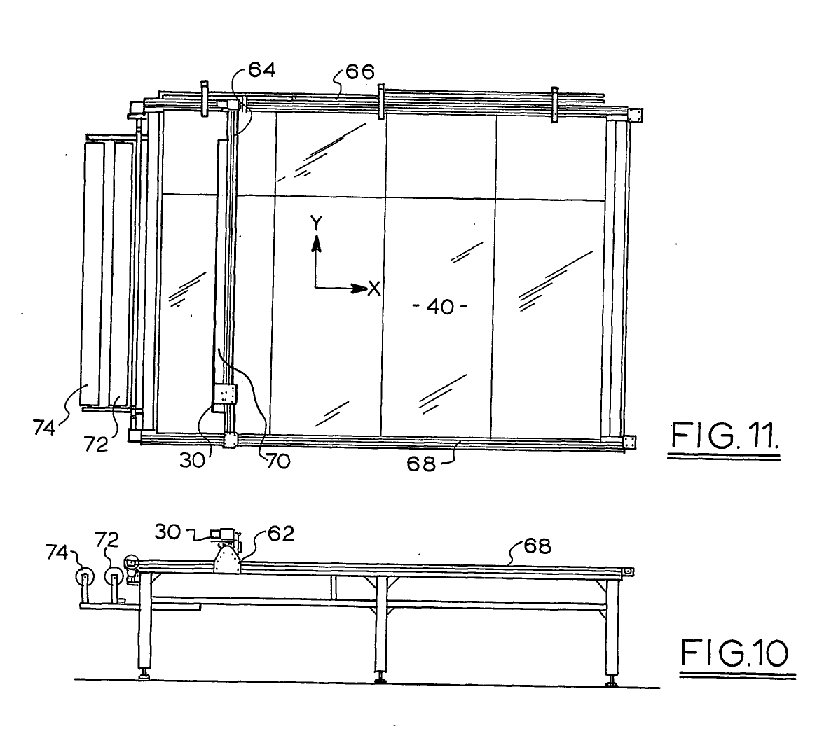

Turning to FIGS. 10 and 11, the laser head 30 is mounted on a carriage 62 which is movably supported on a gantry 64. Thus, the laser head 30 is arranged to move with the carriage 62 along the gantry 64 in a direction indicated as “Y”. The gantry 64 is movably supported on side rails 66 and 68 that are fixed to opposite sides of the bed frame 12. Thus the gantry 64 is arranged to move along the bed frame 12 in a direction indicated as “X”. Attached to the lower part of the carriage 62 is a gripping device 70 for gripping to an edge of the fabric 32 for positioning a length of the fabric 32 onto the surface 40 for cutting. A pair of rollers 72 and 74 are supported at an end of the bed frame 12 and a roll (not shown) of the fabric 32 is rotatably supported on the rollers 72 and 74.

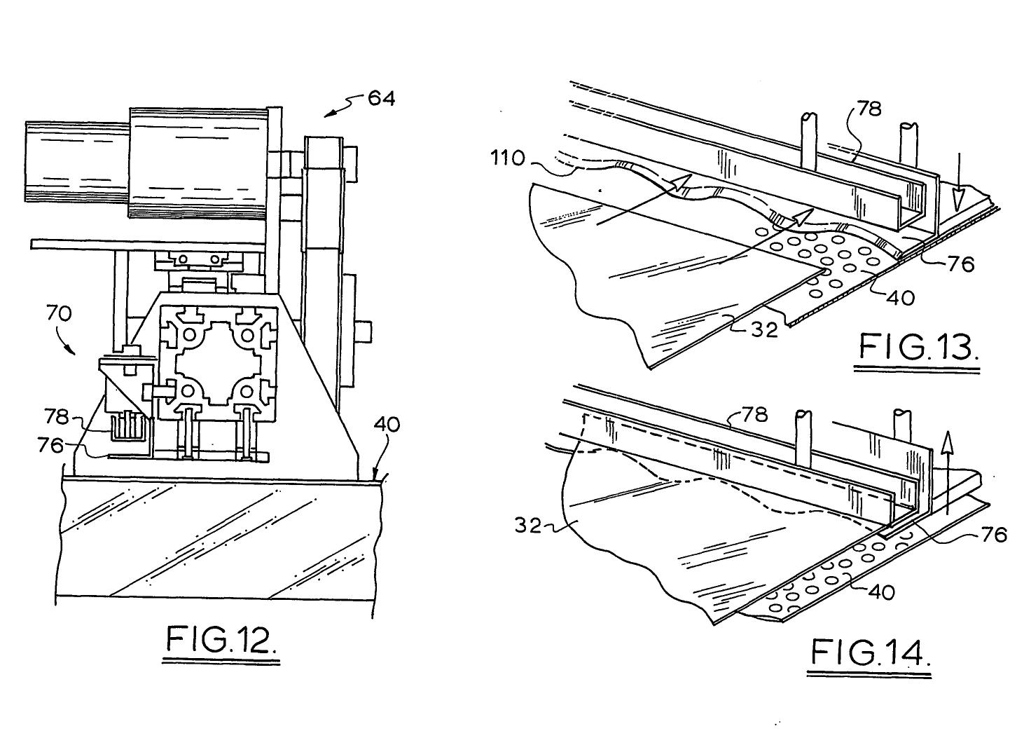

The gripping device 70 as shown in FIG. 12 has a lower movable plate 76 and an upper plate 78 mounted to the underside of the gantry 64. To grip onto the fabric 32, the gantry 64 is controlled to proceed forward with the plate 76 pressed down on the surface 40. The fabric 32 then slides up over the plate 76. As the fabric 32 does not behave in a consistent fashion and may catch on the front edge of the plate 76, for example if the fabric is curled down even though the edge of the plate 76 is sharpened in an attempt to prevent this. The carriage 62, after having gone forward to pick up the fabric 32, then moves back a small amount of distance to allow the fabric 32 to relax, and to allow any catching to unhook, in doing so the fabric 32 flattens out over the plate 76. The plate 76 then lifts up causing the fabric 32 to be clamped in a jaw like fashion between the upper plate 78 and the lower plate 76. The fabric 32 is then pulled out over the surface 40 of the bed frame 12 or carried to the end of the frame 12 if the cutting operation is complete.

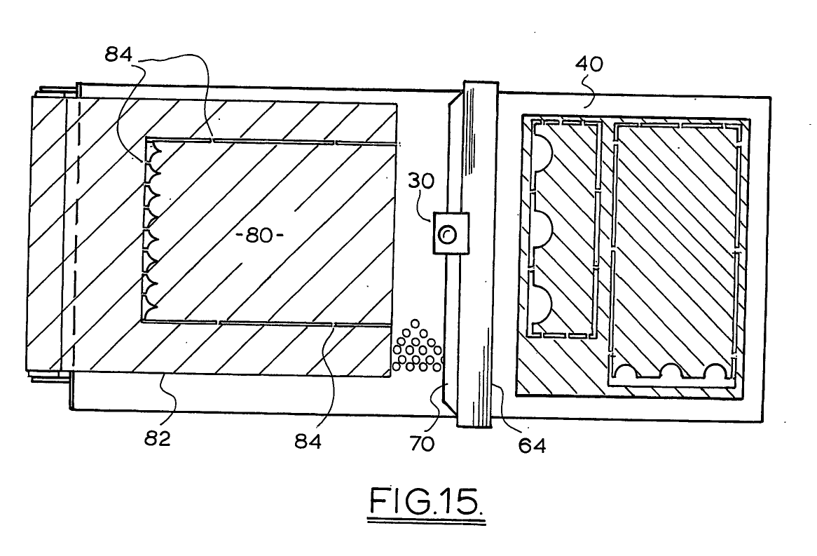

FIGS. 13 and 14 show a form of the lower plate 76 that is configured to substantially minimise curling or folding of the fabric 32 when contacting the lower plate 76 so that the leading edge of the fabric 32 would lie flat when this edge is gripped by the gripping device 70. As can be clearly seen in FIG. 13, in this form the lower plate 76 has a curved or wavy shaped front edge 110 extending across the bed 40. The front edge 110 is knife edge shaped so as to minimise curl ing of the fabric 32 and also to guide the leading edge of the fabric onto the plate 76. The plate 76 is lowered as shown in FIG. 13 when gantry 64 is moving towards the fabric 32. As the gantry 64 moves, the plate 76 will come into contact with the fabric 32. The initial contacts with the fabric 32 are made by the crest parts of the front edge 110. The portions of the leading edge of the fabric 32 that are in contact with the crest parts of the front edge 110 would curl a little and then on further movement of the gantry 64, the plate 76 would move under the curled portions which would then relax and lie flat on the plate 76. The remaining parts of the front edge 110 would in time come under the leading edge of the fabric 32 for gripping between the plates 76 and 78 by upward movement of the plate 76 as shown in FIG. 14. Accordingly, only small parts that are spaced along the front edge 110 are in physical contact with the fabric 32 during the initial contact, The curled portions are relative small area along the leading edge of the fabric 32, and these curled portions quickly relax and return to lie flat on the plate 76. Accordingly, the fabric is less likely to catch on the front edge 110 and the problem of gripping the fabric 32 while in a curled situation is substantially overcome by this form of the plate 76.

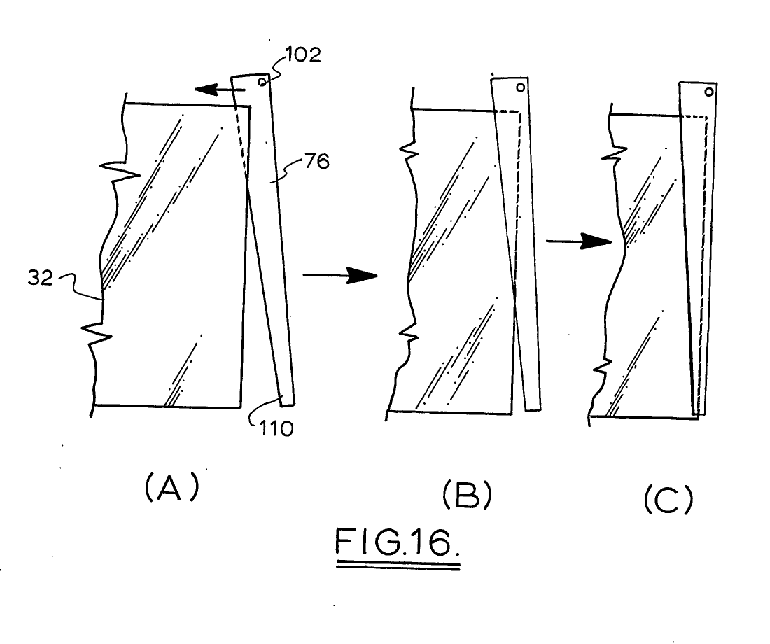

FIG. 16 shows another form of the lower plate 76 for the gripping device 70. In this form the plate 76 is has a substantially straight front edge 110 and is arranged to be pivotally movable in a plane parallel to the bed 40. As can be seen, the plate 76 is pivotally mounted and is rotatable about a pin 102. While the gantry 64 is moving towards the fabric 32, the plate 76 is in position (a) in which it is oriented at angle so that only a corner of the leading edge of the fabric 32 is in contact of the front edge 110 during the initial contact. Thereafter, the plate 76 is controlled to move through position (B) and to the clamping position (C). As shown the leading edge of the fabric is progressively guided to move onto the plate 76 starting from the corner in the initial contact with the edge 110.

The laser cutting operation is controlled so that the cut panel 80 remains connected to the trim around it by means of spaced links 84 as shown in FIG. 15. Thus, the panel 80 and the trim 82 can be transferred from the surface 40 in a single operation step. The panels 80 and any trims 82 (off-cuts) remain connected to one another by a series of small links 84 typically about 1 mm wide and spread at suitable intervals so that the pieces do not break away from each other after transport of the group begins, typically at 200 mm. Separation of the cut panels 80 takes place by breaking the links manually, which by virtue of their small size, or by virtue of the fact that the link is partially cut by the laser (i.e. not fully through), they break apart with ease.

Whilst the above has been given by way of illustrative example of the present invention many variations and modifications thereto will be apparent to those skilled in the art without departing from the broad ambit and scope of the invention as herein set forth in the following claims.

1. A laser cutting apparatus for cutting sheet materials comprising:
a bed having a top surface for a sheet material to be positioned thereon, a gantry being arranged to controllably travel in a first direction along the bed and configured to extend over the bed in a second direction that is substantially transverse to the first direction, and a carriage being arranged to controllably travel along the gantry; the bed having a holding arrangement for holding the sheet material in position on said bed, a laser head located on the carriage and having a laser nozzle arranged to receive a laser beam from a laser source and to direct the laser beam through the laser nozzle and towards the bed for cutting the sheet material, an enclosure member having a first low pressure chamber therein being arranged about the laser nozzle, the first chamber being arranged so that the pressure therein is lower than atmospheric pressure and having at least one suction opening positionable beneath the laser nozzle for entraining substantial by-products produced during cutting of the sheet material into the first chamber and for causing a part of the sheet material under the suction opening to be lifted off the top surface.

2. The apparatus according to claim 1 wherein the holding arrangement includes a second low pressure chamber arranged below the bed and a plurality of through holes extending through the top surface and in fluid communication with the second chamber, the second chamber being arranged so that the pressure therein is lower than atmospheric pressure, thereby causing by-products below the sheet material to be drawn into the second chamber.

3. The apparatus according to claim 2 wherein a relatively high volume low pressure air is arranged to flow through the holes into the second chamber.

4. The apparatus according to claim 2 wherein the first chamber and the second chamber are substantially vacuum.

5. The apparatus according to claim 2 wherein air flows through the first and second chambers being controlled so that there is an air gap between the suction opening and the lifted part of the sheet material, thereby causing air to flow through the air gap and into the first chamber.

6. The apparatus according to claim 1 wherein one or more controllable crease wheels being arranged on the carriage for forming creases in the sheet material.

7. The apparatus according to claim 6 wherein the wheel or each of wheels having a relatively large diameter in comparison to said through holes.

8. The apparatus according to claim 6 wherein the wheel or each of the wheels being configured with a profile to limit depth of creases in the sheet material.

9. The apparatus according to claim 8 wherein the wheel or each of the wheels having a main wheel body and at least one edge portion extending around and protruding from the main body.

10. The apparatus according to claim 9 wherein the wheel or each of the wheels having a single or dual edge.

11. The apparatus according to claim 1 wherein the carriage having a controllable gripping device for gripping a leading edge of the sheet material for positioning same on the bed.

12. The apparatus according to claim 11 wherein the gripping device having an upper plate and a lower plate which is controllably movable relative to said upper plate to clamp the leading edge therebetween when positioning the sheet material on said table.

13. The apparatus according to claim 12 wherein the lower plate is configured with a front edge having one or more pointed or curved sections forward of remaining sections of the front edge, and is arranged so that when the gripping device is moved to contact the leading edge of the sheet material the one or more pointed or curved sections make initial contact with portions of the leading edge of the sheet material before the remaining sections come into contact with the leading edge, thereby causing the initially contacted portion(s) to ride over and then lie flat on said one or more pointed or curved sections.

14. The apparatus according to claim 13 wherein the front edge has a knife edge profile and is wavy shaped with one or more crests.

15. The apparatus according to claim 12 wherein the lower plate having a substantially straight front edge and is pivotally mounted at one end thereof, the lower plate being controlled so that at said initial contact the front edge is at an angle to said leading edge and thereafter the lower plate is pivotally moved in a plane parallel to the flat bed

16. The apparatus according to claim 11 wherein the gripping device is controlled to lower its lower plate on the bed and to move to slide under the leading edge of the sheet material and then to retreat a short distance before returning to clamp the sheet material.

17. he apparatus according to claim 1 wherein the laser head having a cover with a series of apertures arranged to be selectively movable to a position(s) in alignment with the or each of said at least one suction opening and while being moved the by-products caught in the apertures are removed by interaction with the enclosure member.

18. The apparatus according to claim 17 wherein the cover is arranged to be movably mounted on the enclosure member and a retention arrangement is provided for retaining said cover at the position(s) of alignment.

19. The apparatus according to claim 18 wherein the retention arrangement has spaced retention holes in said cover and the retention holes are configured to receive retention elements on said enclosure member.

20. The apparatus according to claim 19 wherein the retention elements are bearings being biassed to be receptive in said retention holes when an aperture(s) in said cover is in the alignment position(s), and upon applying a force to move said cover the bias on the retention bearings is overcome and the bearings thereby retreating from the retention holes to allow movement of the cover relative to the enclosure member towards a subsequent alignment position(s).

21. The apparatus according to claim 1 wherein the sheet material is arranged in a roll form supported on rollers positioned adjacent to the bed table.

22. A laser cutting apparatus comprising:
1) one or a series of rollers on which one or more rolls of a sheet material are placed;
2) a flat bed table on which the sheet material is laid out and the bed table is arranged to hold the sheet material in place by air suction;
3) a gantry is arranged to move in a first direction along the table;
4) a gripping device and a controllably movable carriage mounted on the gantry, the gripping device being arranged to controllably clamp the sheet material and to pull the sheet material across the table, and the carriage being arranged to move along the gantry in a second direction which is substantially transverse to said first direction; and
5) the carriage having mounted thereon a pair of controllable crease wheels for forming crease lines into the sheet material, and a controllable laser head for cutting the sheet material.

23. A laser head for a sheet material cutting apparatus, the laser head comprises a laser nozzle arranged for connection to a laser source and to direct a laser beam generated from the laser source therethrough and towards the sheet material, and an enclosure member being arranged about the laser nozzle and having a first low pressure chamber therein. the first chamber is arranged so that the pressure therein is lower than atmospheric pressure and has at least one suction opening positionable beneath the laser nozzle for entraining substantial by-products produced during cutting of the sheet material into the first chamber, a cover having a series of apertures is arranged to be selectively movable to a position(s) in alignment with the or each of said at least one suction opening and while being moved the by-products caught in the apertures are removed by interaction with the enclosure member.

24. The laser head according to claim 23 wherein the cover is movably mounted on the enclosure member, and a retention arrangement is provided for retaining said cover at the position(s) of alignment.

25. The laser head according to claim 24 wherein the retention arrangement has spaced retention holes in said cover and the retention holes are configured to receive retention elements on said enclosure member.

26. The laser head according to claim 24 wherein the retention elements are bearings biassed to be receptive in said retention holes when an aperture(s) in said cover is in the alignment position(s), and upon applying a force to move said cover the bias on the retention bearings is overcome and the bearings thereby retreating from the retention holes to allow movement of the cover relative to the enclosure member towards a subsequent alignment position(s).

27. A gripping device for a cutting apparatus having a flat bed table on which a sheet material to be cut is laid out, the device comprises an upper plate member and a lower plate member arranged to be movable relative to said upper plate member between a clamping position for clamping the sheet material therebetween and a pickup position for picking up the sheet material, the plate members being arranged to move in a first direction along the table and to controllably clamp a leading edge of the sheet material, the lower plate is configured with a front edge opposite to said leading edge and is arranged so that at said pickup position movement thereof to contact the sheet material causes a relatively small part or parts along the leading edge to come into an initial contact with the front edge and further movement thereof causes other parts along the leading edge to progressively come into contact with the front edge and to lie over the front edge for clamping between the upper and lower plate members.

28. The device according to claim 27 wherein the front edge has a knife edge profile and is wavy shaped with one or more crests.

29. The device according to claim 27 wherein the lower plate has a substantially straight front edge in a knife edge profile and is pivotally mounted at one end thereof, the lower plate being controlled so that at said initial contact the front edge is at an angle to said leading edge and thereafter the lower plate is pivotally moved in a plane parallel to the flat bed of said table so that the front edge is substantially parallel to said leading edge.
